(19) United States
(12) Patent Application Publication
(10) Pub. No.: US 2013/0167972 A1
(43) Pub. Date: Jul. 4, 2013

(54) Device For Handling Drums, Equipment For Transferring Powder Material, And Transfer Method

(71) Applicant: Yvan Peressoni, Bagnols sur Ceze (FR)

(72) Inventor: Yvan Peressoni, Bagnols sur Ceze (FR)

(73) Assignee: AREVA NC, Paris (FR)

(21) Appl. No.: 13/818,657

(22) PCT Filed: Aug. 26, 2011
(86) PCT No.: PCT/EP11/64694

§ 371 Date: Feb. 23, 2013

(30) Foreign Application Priority Data
Aug. 26, 2010 (FR) 1056786

(51) Int. Cl. B65G 65/30

(52) U.S. Cl. CPC B65G 65/30
USPC 141/1; 141/250

(57) ABSTRACT

Equipment to transfer powder from a drum into a tank comprising at least one handling device and one hopper assembly (T) connected to a tank (4). The handling device comprises a hollow cylindrical body intended to surround a drum (2) and to immobilise it to enable it to be turned upside-down, where the drum (2) is open and the powder is contained in at least one sealed bag. The hopper assembly (T) comprises a hopper (60) and a sealed enclosure (62) installed on the upstream end of the hopper, where said enclosure (62) comprises an aperture to enable the hollow cylindrical body loaded with the drum (2) and of the sack of powder to enter, and then, after removal of the hollow cylindrical body loaded with the empty drum (2), to be closed, and to allow the bag to be opened to allow the powder to flow into the hopper (60).

### TECHNICAL FIELD AND PRIOR ART

The present invention relates to a device for handling drums containing powder material, to equipment for transferring powder material, and to a transfer method using such equipment. The powder material is contained in drums; it may be, for example, uranium oxide (UO₂) for the manufacture of nuclear fuel pellets.

Nuclear fuel pellets, such as for example pellets of MOX (a blend of plutonium oxide and uranium oxide), are manufactured from blended powder materials, pressed into the shape of pellets and then sintered.

A proportion at least of the powder materials is conveyed in sealed drums, to a pellet manufacturing facility. The content of the drums is then emptied into hoppers directed towards storage areas.

In a known manner, the drums are opened, and then turned upside-down over a hopper positioned at the entrance to the equipment; the material in powder form then flows into the hopper, as far as a storage location, before being used. There is a confinement system between the drum and the hopper.

On the one hand, since the powder is placed directly in the drums the latter are polluted; they are then considered to be nuclear waste, and must be processed as such. Constant efforts are made to reduce the quantity of waste produced. In addition, the hopper is itself also polluted. A lengthy task of sanitisation of the hopper is then required. In addition, the confinement used is relatively complex.

It is consequently one aim of the present invention to provide equipment and a method for transferring powder contained in a drum towards a storage area which provides efficient confinement of the powder, and isolates it from outside elements.

### DESCRIPTION OF THE INVENTION

The aim set out above is attained by means of equipment to transfer powder from a drum to a storage area comprising a hopper connected to this storage area, and a confinement air lock upstream from the hopper, connected in sealed fashion to the latter, where said air lock comprises an aperture in its upper portion opposite the hopper, which can be closed in sealed fashion, and where the air lock also comprises sealed access hatches in its side walls to allow the operators to intervene on the content of the lock. In addition, the powder stored in the drum is confined at least in a first bag within the drum. A handling system also enables the bag of powder contained in the drum to be transferred to within the confinement lock.

In other words, a glove box is fitted above the hopper, which can be opened at its upper end to install bags containing powder and which, when it is closed, confines the powder, and allows intervention on the bags of powder in perfect safety through the glove ports of the glove box.

In a particularly advantageous manner, a bag is fitted to the inside of the drum, in which the bag directly containing the powder is placed.

Also in a particularly advantageous manner, a consumable sleeve is fitted to the inside of the glove box to prevent any transfer between the inside and the outside of the glove box, limiting by this means any pollution of the external portion of the glove box and/or any pollution of the powder.

The subject-matter of the present invention is then a drum-handling device leading to a hopper assembly for transferring at least one powder material contained in the drum towards an area for storage of said material, where said drum contains at least one closed bag containing said at least one powder material, where said handling device comprises a frame intended to be suspended from a hoist, a hollow cylindrical body installed in the frame which can pivot around a horizontal axis perpendicular to a lengthways axis of the hollow cylindrical body, where the hollow cylindrical body comprises a first open lengthways end, a second lengthways end equipped with means for sealing said second end, where said sealing means are retractable, where the internal dimensions of the hollow cylindrical body are such that they allow the drum to be introduced into the hollow cylindrical body, where this body has means of immobilising the drum in the hollow cylindrical body, and means able to cause a 180° rotation of the hollow cylindrical body around its axis of rotation relative to the frame, and where said cylindrical body containing the drum is intended to enter into the hopper assembly.

According to an additional characteristic, the drum-handling device according to the present invention comprises means for locking the hollow cylindrical body in an upside-down position.

For example, the retractable sealing means comprise at least two lobes connected such that they are able to rotate on the hollow cylindrical body, and means of operating said lobes comprising at least one linear actuator installed on the hollow cylindrical body connected to the lobes by connecting rods.

The linear actuator is preferably installed on the hollow cylindrical body opposite its sealed end, and said linear actuator is connected to the connecting rods by means of a tube which can move along the axis of the hollow cylindrical body, and which forms an outside wall of said hollow cylindrical body. The linear actuator is advantageously of the irreversible type.

In an example embodiment, the immobilisation means are such that they come into contact with the drum in its median portion. The immobilisation means can comprise at least two holding jaws intended to come into contact with the outer surface of the drum, and means able to apply the holding jaws and to keep these pressed on the drum which are, for example, formed by handles accessible from the outside of the hollow cylindrical body, and imparting action to the holding jaws by means of toggle locks.

In one example embodiment the means for turning the drums upside-down comprise a toothed wheel engaged with the rotary shaft of the hollow cylindrical body, a toothed wheel on the frame, a transmission element connecting the two toothed wheels, and means to cause the toothed wheel on the frame to rotate. The means causing the toothed wheel to rotate on the frame can comprise a control wheel connected to said toothed wheel by a reducing gear.

According to an additional characteristic, the device for handling drums according to the invention preferably comprises a device supporting the frame to enable it to be stored and to turn the hollow cylindrical body upside-down.

Another subject-matter of the present invention is a hopper assembly comprising a hopper intended to be connected by its downstream end to a tank of powder material, and a sealed enclosure installed in sealed fashion on the downstream end of the hopper, where said enclosure comprises a side wall, a base on the side of the hopper and an aperture opposite said base intended to enable the drum held in the hollow cylindrical body of the handling device according to the invention to be introduced into the enclosure, where the drum is in an upside-down position, with the aperture downwards; the enclosure also comprises a cover to close and protect said aperture mechanically, sealed access means allowing intervention in the enclosure, and means for sealed transfer of the objects between the interior of the enclosure and outside of it, where the base of the enclosure is formed at least partly by grids positioned between the enclosure and the hopper.

The internal dimensions of the enclosure and of the aperture of the enclosure are then made such, for example, that they enable the hollow cylindrical body and the frame surrounding the hollow cylindrical body to be introduced into the enclosure.

The hopper assembly advantageously comprises means of generating a depression within the hopper assembly. The means of generating a depression preferably generate a depression containing nitrogen. The hopper assembly may additionally comprise means to produce a depression containing air.

The sealed access means and the sealed transfer means are advantageously formed in the side wall and are, for example, glove ports and bag ports respectively, respectively of the glove box type.

The hopper assembly according to the present invention may preferably comprise a consumable sleeve fitted to the inside of the side wall of the enclosure and the base of the enclosure.

Another subject-matter of the present invention is equipment for transferring powder from a drum into a tank comprising at least one handling device according to the present invention, and one hopper assembly according to the present invention.

Another subject-matter of the present invention is a method for transferring powder material contained in a drum to a tank in equipment according to the present invention, where the powder material is stored in at least one first bag in the drum, comprising the following steps:
opening of the drum,
installation of the hollow cylindrical body around the drum, the sealing means being positioned above the aperture of the drum,
immobilisation of the drum in the hollow cylindrical body,
turning of the drum upside-down,
installation of the hollow cylindrical body and of the drum in the enclosure,
actuation of the sealing means to allow said first bag of powder material to fall, with said first bag resting on the grid,
removal of the hollow cylindrical body,
closure of the aperture of the enclosure in sealed fashion,
start-up of the depression system,
opening of the first bag,
emptying of the first bag in the enclosure,
removal of the first bag.

The drum advantageously comprises a second bag fitted to the interior of the drum, in which the first bag directly containing the powder material is positioned, comprising the step of installation of a cap on the aperture of the drum after the latter is opened, where the second bag fitted to the drum and the cap fall into the enclosure at the same time as the first bag directly containing the powder material, and where said second bag is perforated when the first bag directly containing the powder is opened.

The transfer method according to the present invention may comprise, according to an advantageous characteristic, before the hollow cylindrical body and the drum are introduced into the enclosure, the step of installation of a sleeve in the enclosure covering its side wall and its base, where said sleeve is perforated when the bag directly containing the powder is opened.

The transfer method according to the present invention may comprise a step of installation of a cap on the aperture of the enclosure after the hollow cylindrical body is removed.

Very advantageously, to perform the step of turning the drum upside-down, the frame may be installed on the frame mount.

### BRIEF DESCRIPTION OF THE ILLUSTRATIONS

The present invention will be better understood using the description which follows and the appended drawings, in which:

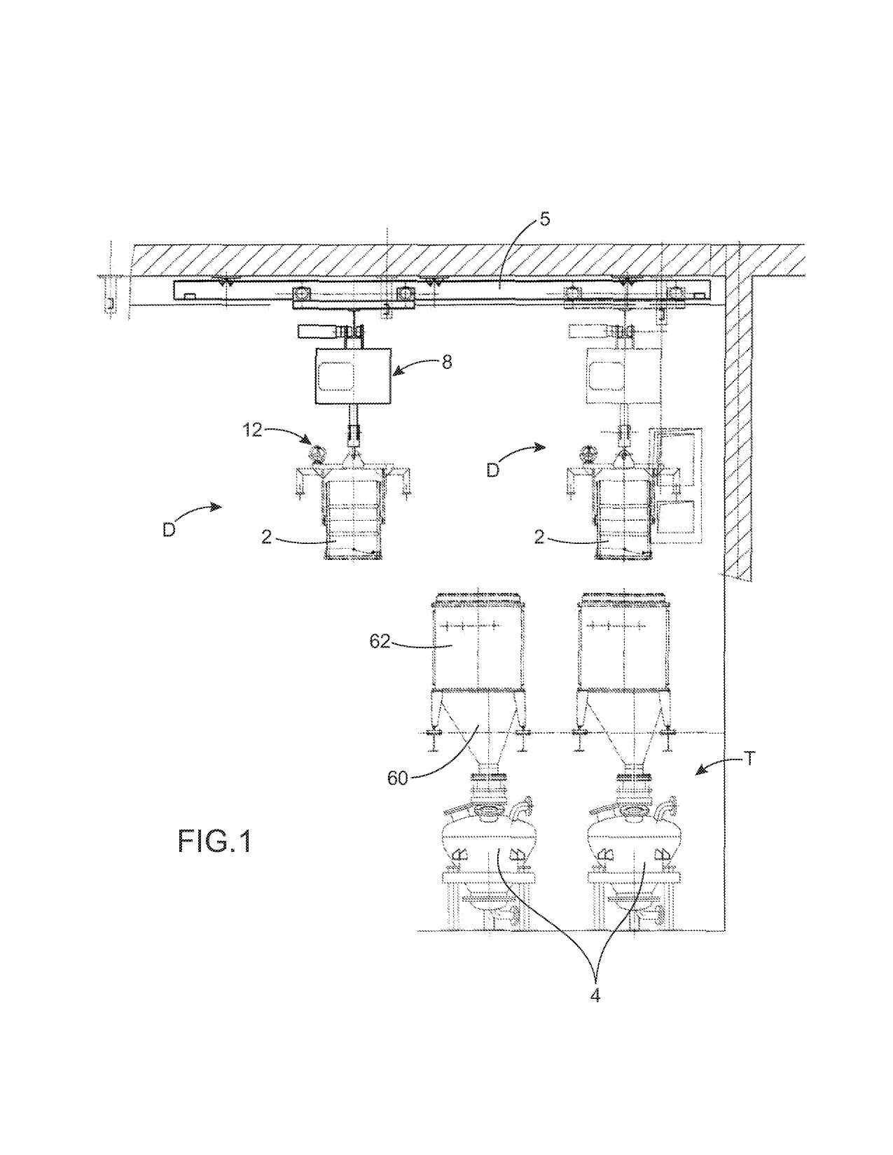

FIG. 1 is an front view of an example embodiment of equipment for transferring powder according to the present invention,

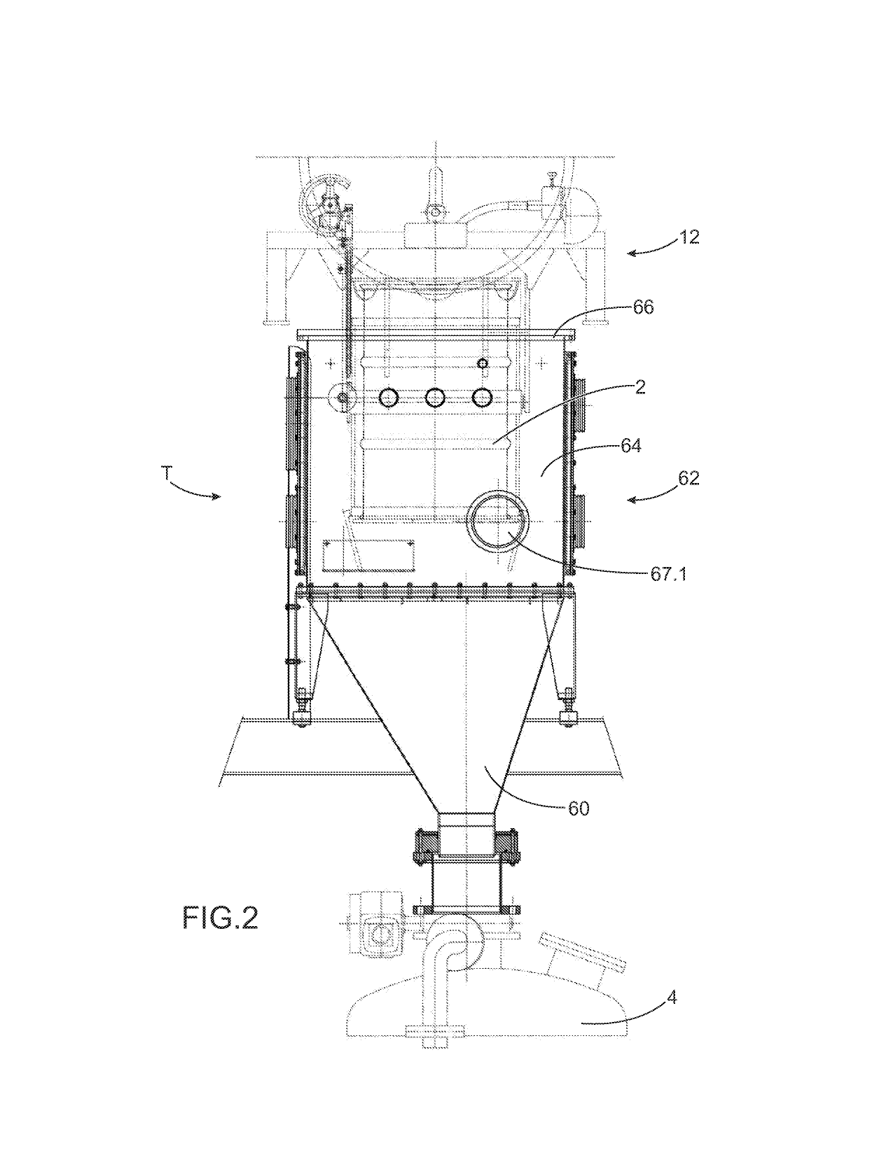

FIG. 2 is an front view of a hopper assembly according to the present invention with, represented using a dotted line, a drum inside the hopper assembly,

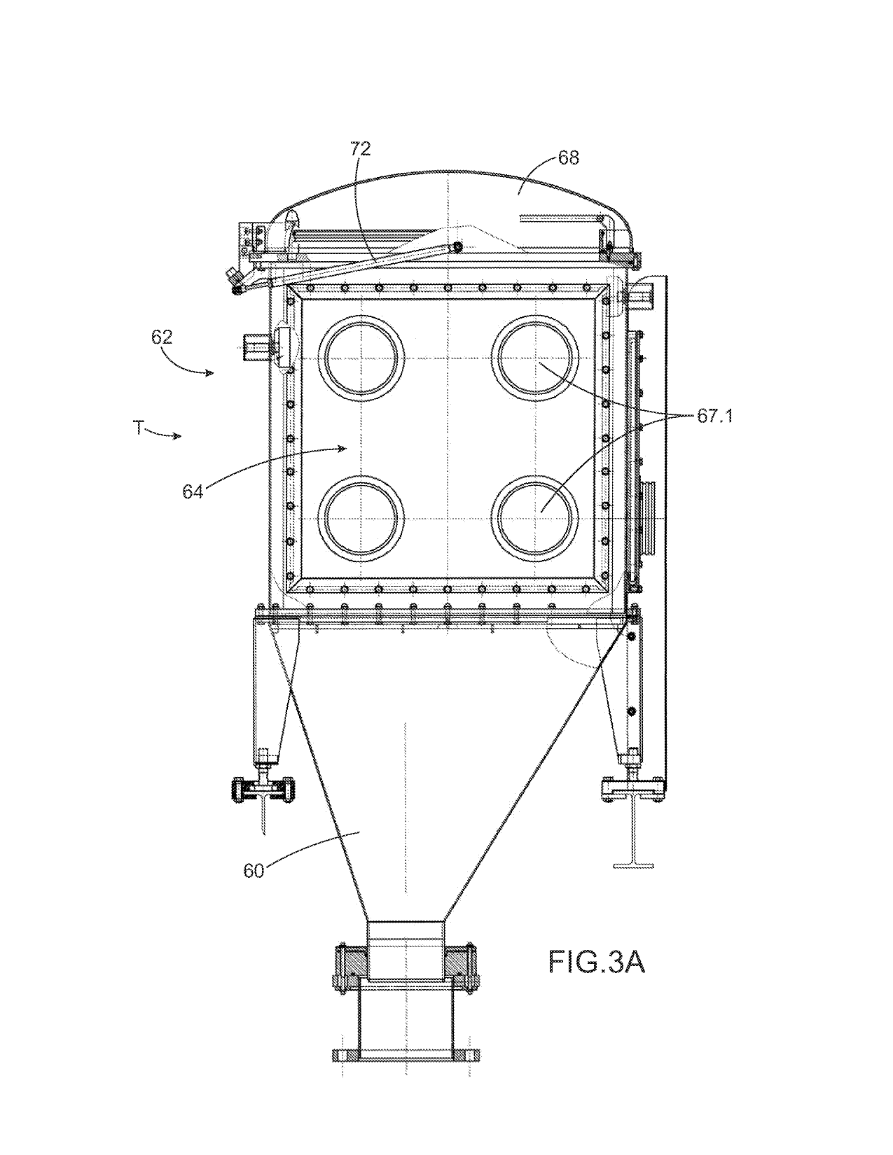

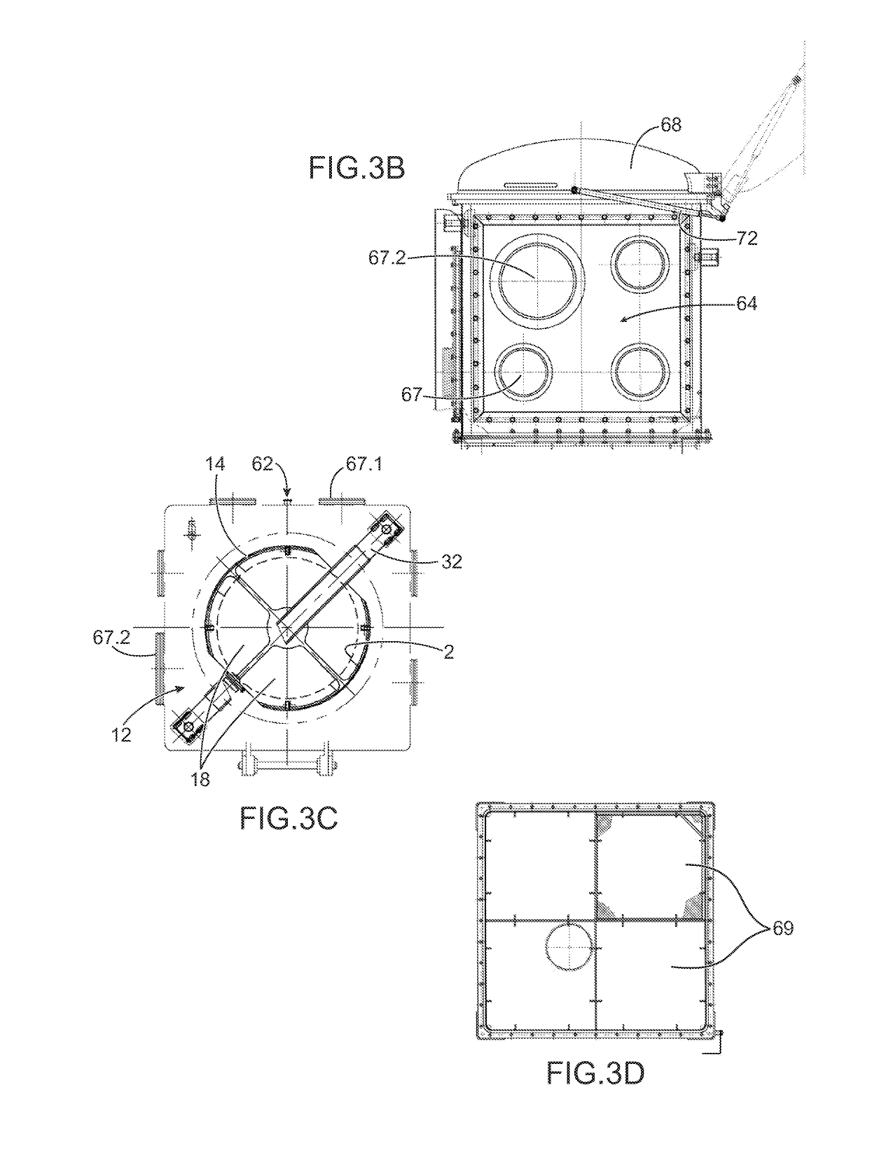

FIG. 3A is a view of one side of the hopper assembly of FIG. 2, where the hopper assembly is closed in sealed fashion,

FIG. 3B is a partial view of another side of the hopper assembly of FIG. 2, where the hopper assembly is closed in sealed fashion, and where the side has glove ports and a bag port,

FIG. 3C is a top view of FIG. 3A with the drum in the hopper assembly,

FIG. 3D is a transverse section view of the base of the enclosure of the hopper assembly,

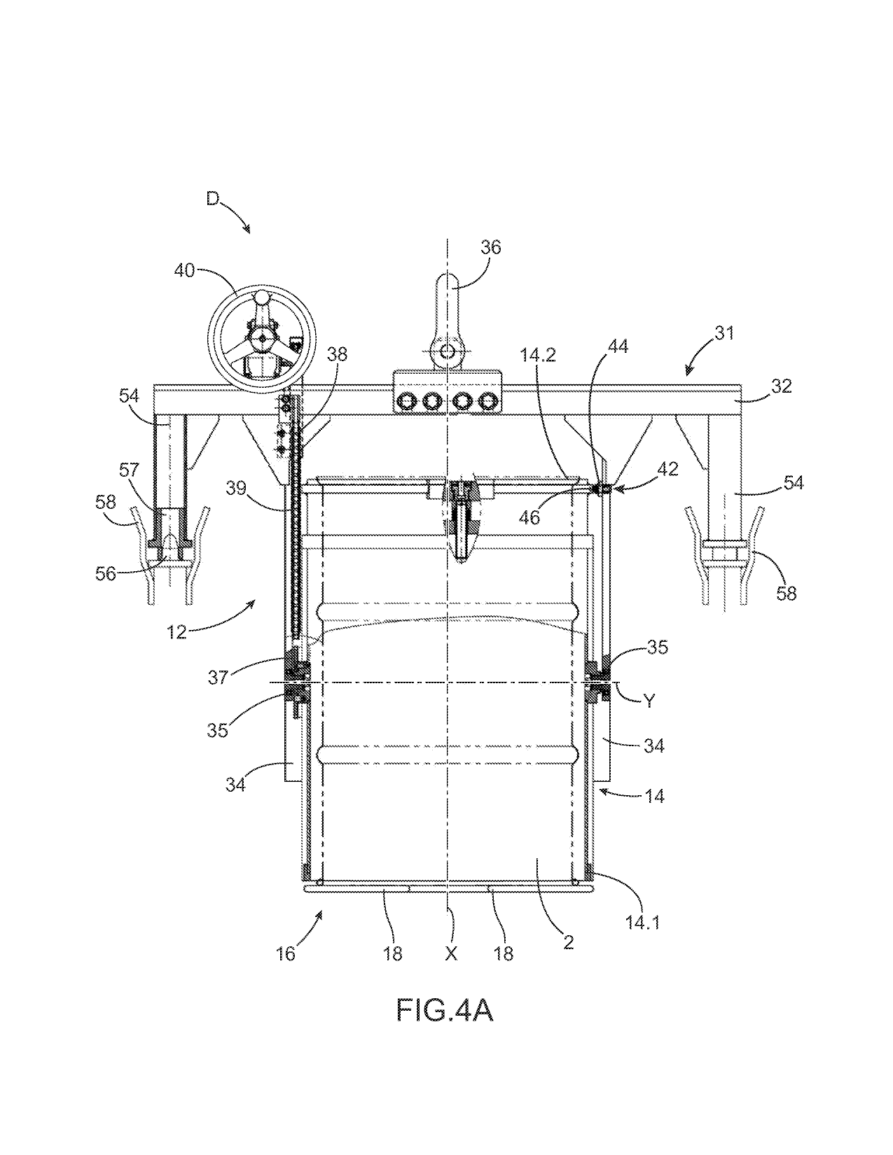

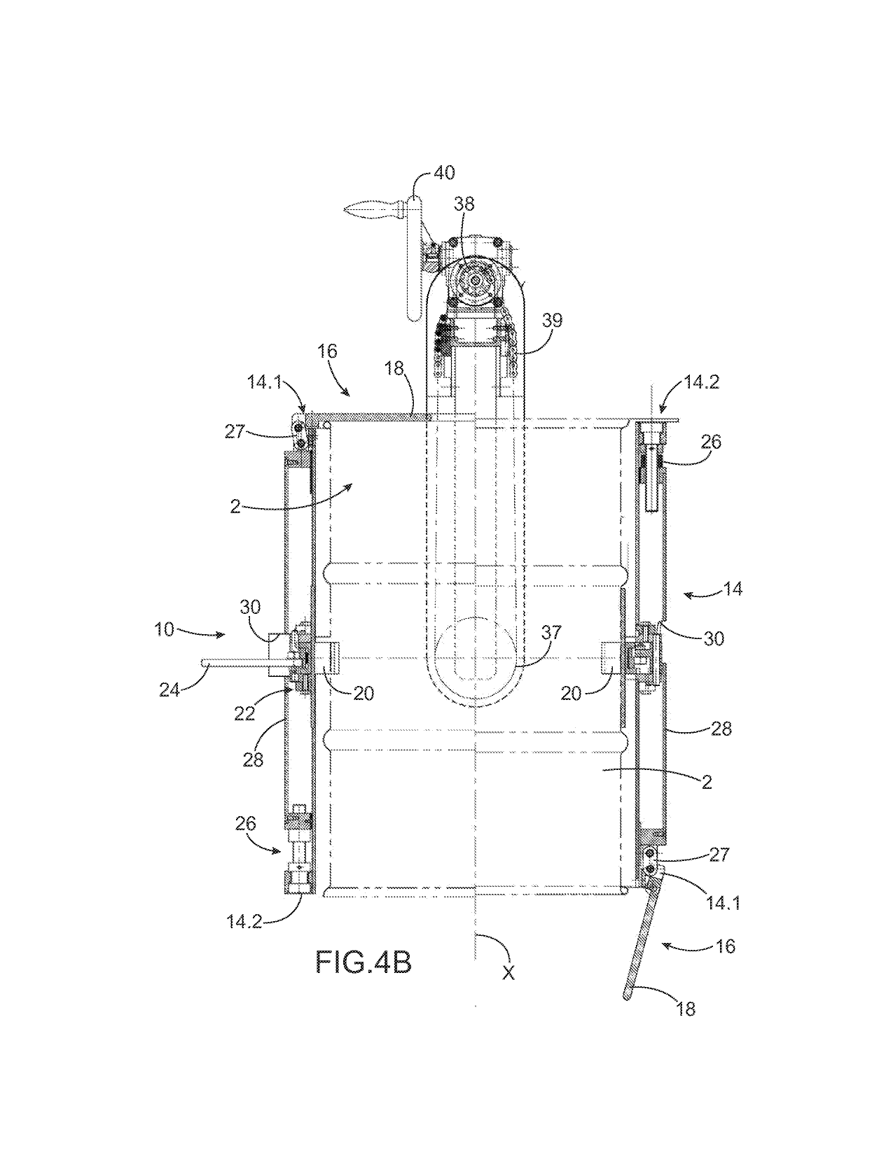

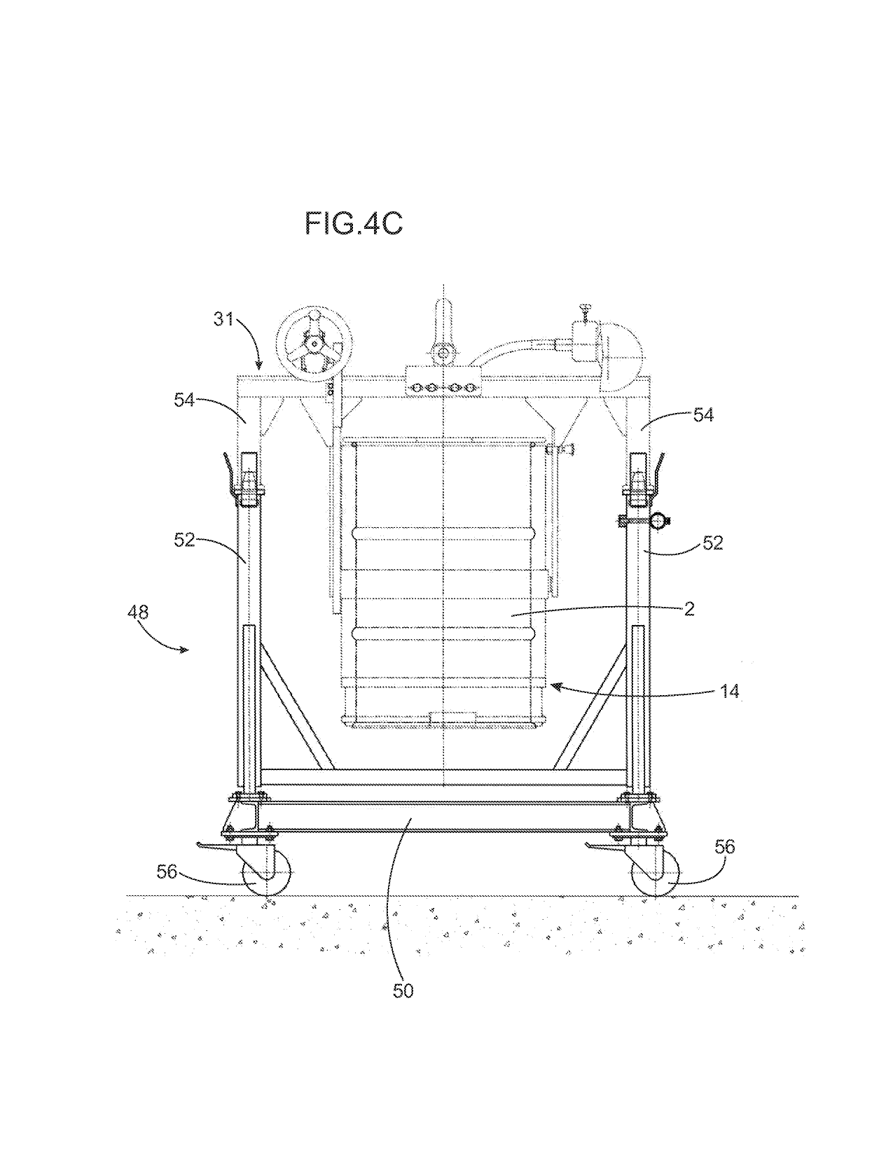

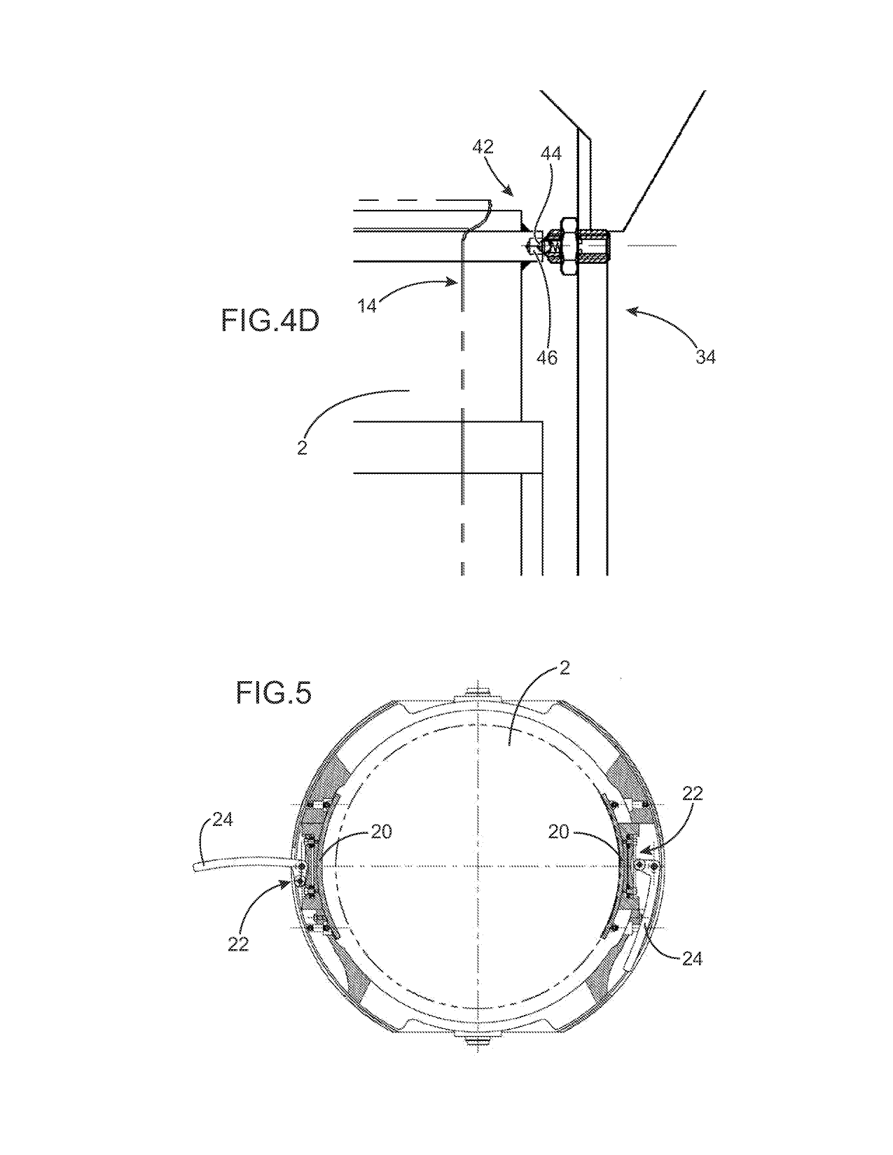

FIG. 4A is a front view of the drum-handling device according to the present invention with a drum, in a “downwards drum opening” position,

FIG. 4B represents two lengthways section half-views of the handling device of FIG. 4A, where the left-hand half-view represents a state of “taking the drum” and the right-hand half-view represents a “drum upside-down” state,

FIG. 4C is a front view of the drum-handling device of FIG. 4A on a seating for storing the drums and turning them upside-down,

FIG. 4D is a detailed view of the drum-handling device of FIG. 4A showing the locking means of the drum in the upside-down position;

FIG. 5 is a transverse section view of the handling device of FIG. 4B showing the drum's locking means, where the latter are, in the left-hand half-view, in an unlocked position, and in the right-hand half-view in a locked position on the drum,

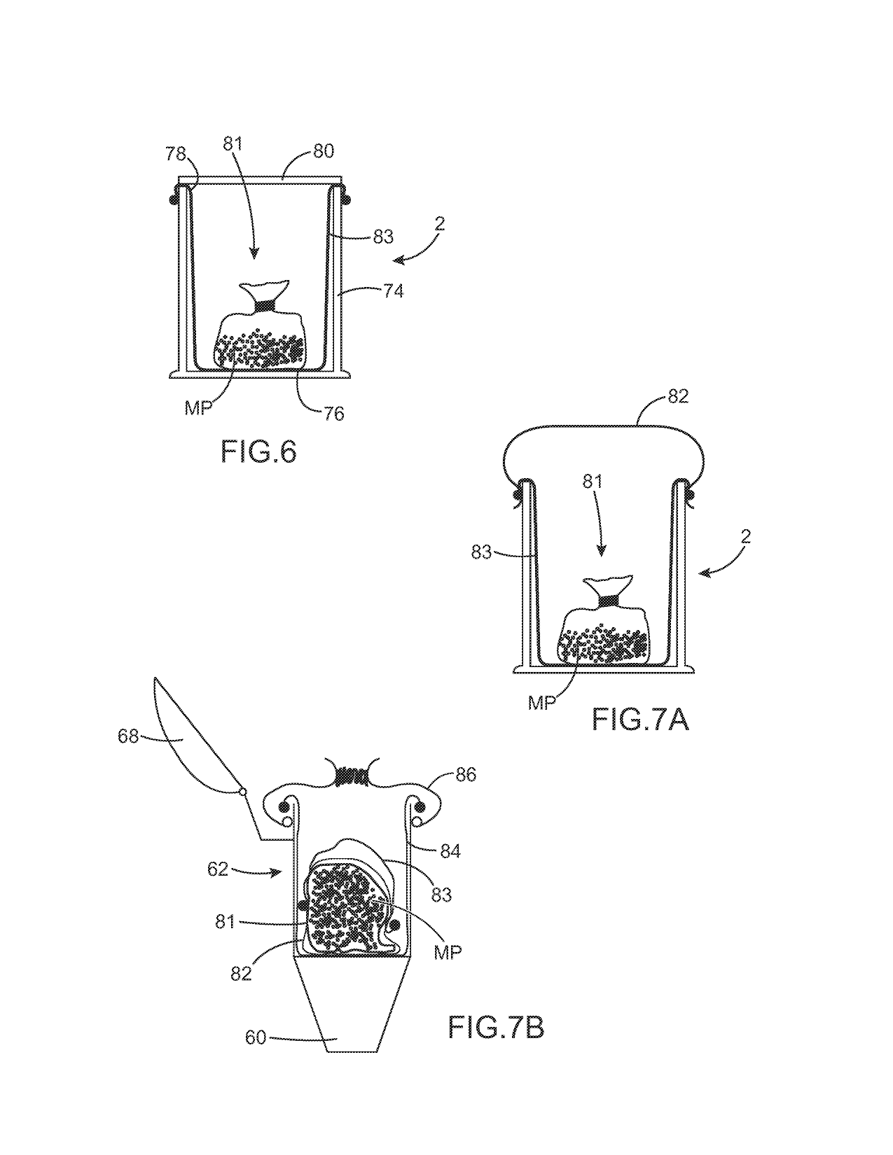

FIG. 6 is a schematic lengthways section view of a drum which is particularly suitable for the equipment according to the present invention,

FIGS. 7A and 7B are schematic representations of different steps of the transfer method according to the present invention.

### DETAILED ACCOUNT OF PARTICULAR EMBODIMENTS

In FIG. 1 an overall view of the transfer equipment according to the present invention can be seen, comprising a device D for handling drums 2 and a hopper assembly T.

In the represented example the equipment comprises two drum-handling devices D and two hopper assemblies T. A single device D for handling drums 2 and a single hopper assembly T will be described in detail.

Each hopper assembly T is connected in sealed fashion to a powder storage area 4.

In the represented example handling device D comprises a travelling crane 5 and a trolley 6 which moves on travelling crane 5, and a hoist 8 able to move the drum vertically. The handling device comprises means 10 for immobilising the drum, and means 12 to cause it to be turned upside-down, such that it changes from a “top opening” position to a “bottom opening” position.

The travelling crane comprises at least one rail, and covers an area between a drum storage area and the hopper assembly.

In FIGS. 4A and 4B, drum handling device D comprising system 10 for immobilising the drum 2 and system 12 for turning drum 2 upside-down can be seen.

Handling device 10 comprises a hollow cylindrical body 14 with a lengthways axis X intended to surround drum 2. Hollow cylindrical body 14 is open at both lengthways ends 14.1, 14.2 and comprises means 16 to close one of lengthways ends 14.1 of hollow cylindrical body 14.

The transverse section of hollow cylindrical body 14 preferably matches that of drum 2. In the represented example, drum 2 has a circular transverse section, and the hollow cylindrical body has a transverse section which is also circular. As a variant, the drum could have a polygonal or elliptical section; in this case the hollow cylindrical body would preferably have a corresponding polygonal or elliptical section.

In the represented example, closing means 16 are formed by four lobes 18 having the shape of quarter discs connected such that they can rotate on hollow cylindrical body 14 around axes orthogonal to lengthways axis X, and such that they may or may not close lengthways end 14.1. The four lobes 18 can be seen in FIG. 4B.

Means 10 of immobilising the drum ensure that drum 2 is immobilised in both lengthways and transverse directions within hollow cylindrical body 14 by clamping. These can be seen most clearly in FIG. 5. The immobilisation means are installed, in the represented example, roughly at mid-height of the hollow cylindrical body. These immobilisation means 10 comprise at least two holding jaws 20 intended to be applied against the outer face of the drum, a toggle joint 22 and a handle 24 associated with each of the jaws. The hinge lines of the toggles are roughly parallel to lengthways axis X. Jaws 20 have curved surfaces matching the curvature of the external surface of the drum. Holding jaws 20 are positioned inside hollow cylindrical body 14; handles 24 are positioned outside hollow cylindrical body 14 in order that they are accessible from the outside. In the represented example, immobilisation means 10 comprise two diametrically opposite holding jaws 20. It is clearly understood that a higher number of jaws may be used.

It is clearly understood that any other means to apply the jaws to the drum may be used in connection with the present invention. In addition, in the represented example, the jaws are tightened and untightened manually. As a variant, these actions could be automated, by means of electrical, pneumatic, etc. systems. Correct tightening of the drum is checked visually, for example.

Lobes 18 of the sealing means can be moved between a sealing position as represented in FIG. 4A and an unsealed position represented in FIG. 4B (right-hand half-view). In the represented example the means to move the lobes comprise a linear actuator 26 connected to lobes 18 by means of connecting rods 27. For example, one connecting rod is associated with each lobe 18.

Linear actuator 26 is connected to four connecting rods 27 via a transmission element 28. In the represented example transmission element 28 is formed by a moving tube 28 forming the outer wall of hollow cylindrical body 14, which can slide along longitudinal axis X relative to an internal wall of hollow cylindrical body 14.

Linear actuator 26 is advantageously an irreversible spindle-nut system, preferentially with a trapezoid pitch. The spindle-nut system is, for example, operated manually using a tool, for example a ratchet key.

In the represented example, linear actuator 26 is positioned at longitudinal end 14.2 of hollow cylindrical body 14 opposite the end where lobes 18 are installed. This positioning of the linear actuator enables it to be operated easily from above when the bag is placed in the hopper.

As a variant, the actuator could be located as close as possible to the connecting rods, or the transmission tube could be replaced by one or more transmission shaft(s) connected the connecting rods via a ring.

The device advantageously comprises a single linear actuator 26 for all four lobes 18; however, the choice could be made to operate each of the lobes separately.

Tube 28 comprises apertures 30 in the area of the immobilisation means to enable handles 24 to be operated. The dimensions of apertures 30 are sufficient to prevent any contact between handles 24 and moving tube 28 when moving tube 28 is moved.

Use of a tube forming an external wall of hollow cylindrical body 14 as transmission means 28 has the advantage that it provides a handling device having few visible mechanical elements, and where tube 28 forms a cover, reducing the risks of injury to the operators, and the risks of damage in the event of an accidental impact. The translation guidance is also simplified. In the represented example, the sliding of the external wall is guided by a metal-metal contact. Other means could of course be used.

The handling device also comprises a frame 31 comprising a beam 32, and two struts 34 attached rigidly to the beam, extending downwards perpendicularly to beam 32. Struts 34 are positioned vertically. Beam 32 is fitted with a means 36 by which it is fastened to hoist 8; in the represented example this is a ring. Hollow cylindrical body 14 is positioned between the two vertical struts 34 and is connected such that it can rotate on the latter around a horizontal axis Y parallel to beam 32. The rotation of hollow cylindrical body 14 allows drum 2 to be turned upside-down.

The connection such that it can rotate of hollow cylindrical body 14 is accomplished by means of two bearings.

As can be seen more clearly in FIG. 4B, means 12 to turn the drum upside-down, in the represented example, comprise a first toothed wheel 37 attached to the outer face of hollow cylindrical body 14, and coaxial with axis Y, a second toothed wheel 38 connected to beam 34, having its axis parallel to axis Y, and a chain 39 to transmit the rotation of second toothed wheel 38 to first toothed wheel 37. Second toothed wheel 38 is rigidly attached to control wheel 40 such that both can rotate together. In the represented example, control wheel 40 is not directly engaged with the shaft of second toothed wheel 38, but is engaged with the shaft of the second toothed wheel through a reducing gear with a wheel and an irreversible endless screw, to facilitate the operation of turning the drum upside-down. In the represented example control wheel 40 is in a plane orthogonal to the plane of second toothed wheel 38, facilitating installation of control wheel 40.

As a variant, chain 39 could be replaced by a toothed belt. The control wheel could be replaced by an electric motor or any other type of actuator.

It is clearly understood that other means could be used to turn the drum upside-down, for example a motor directly engaged with the drum's rotary shaft.

The drum handling device advantageously comprises means 42 to lock the drum in an upside-down position, represented in FIG. 4D. In the represented example these locking means 42 are formed by a slug 44 installed in one of vertical struts 34, one end of which is intended to penetrate into a bore 46 of hollow cylindrical body 14. When the end of slug 44 enters bore 46 hollow cylindrical body 14 is prevented from tipping. Bore 46 is made in hollow cylindrical body 14 at its end 14.2 opposite end 14.1 with the lobes, and slug 44 is installed in a portion of the vertical strut on the side of beam 32, as far as possible from axis of rotation Y. Slug 44 is, for example, of the retractable-ball type, fitted with a return spring. Slug 44 is then moved by cylindrical body 14 when the latter rotates.

It is clearly understood that other means of locking the hollow cylindrical body are conceivable, for example at the axis of rotation X.

Frame 31 is intended to be positioned on a seating 48 represented in FIG. 4C, firstly for storage purposes, and secondly to allow drum 2 to be turned upside-down. Indeed, it is preferable to turn the drum upside-down in a position where the frame is immobilised, and not when it is suspended from the crane, in order to reduce the risks of instability and swaying. Indeed, when the drum is turned upside-down the powder contained in the drum will fall inside the drum and cause a swaying action.

Seating 48 comprises a platform 50 and two vertical braces 52 intended to support the beam. In the represented example, the frame comprises two vertical struts 54 which rest on both vertical braces 52 of seating 48. The choice could be made for beam 32 to rest directly on the vertical braces.

Preferably, and as is represented in FIG. 4A, the upper ends of the vertical braces comprise slugs 56 intended to enter bores 57 in the struts 54 to provide a transverse hold between vertical braces 52 and struts 54. In addition, slugs 56 are advantageously lined with guidance means 58 to facilitate the installation of struts 54 on vertical braces 52. These guidance means 58 are formed, for example, by lugs delimiting a wide-mouthed aperture which narrows towards the end the slugs. The seating advantageously comprises rollers 56 enabling it to be moved easily, and to be placed under the handling device.

When frame 31 is on seating 48 the drum can be turned upside-down easily, by operating control wheel 40.

We shall now describe the hopper assembly represented in FIGS. 2, 3A and 3D.

The hopper assembly is positioned above the powder storage means formed in FIG. 1 by a conically-shaped tank 4.

The hopper assembly comprises a hopper 60 positioned directly above tank 4 and connected in sealed fashion to an aperture for filling the tank.

In addition, the hopper assembly comprises a sealed enclosure 62 extending the upper end of hopper 60, forming a sealed assembly with the hopper.

Enclosure 62 comprises side walls 64 and an aperture 66 in its upper end which can be closed in sealed fashion by a cover 68, the latter being installed in articulated fashion on one of the walls around a horizontal axis.

The transverse dimensions of enclosure 62 and those of the upper end of hopper 60 are advantageously roughly identical, reducing the “dead” zones where powders may accumulate. In the represented example, hopper 60 has a pyramid shape, and the enclosure is formed by a rectangular parallelogram.

The internal dimensions of enclosure 62 and of aperture 66 are such that the assembly formed by drum 2, hollow cylindrical body 14 in which the drum is immobilised, and the vertical struts either side of hollow cylindrical body 14, can enter into enclosure 62. As can be seen in FIG. 3C, advantageously enclosure 62 has a square section, and the length of the diagonal is such that it enables the frame to be introduced into the enclosure by aligning the beam with the diagonal of the square. The dimensions of the enclosure can then be made smaller.

In addition, the walls of the enclosure are fitted with glove ports 67.1 (FIGS. 3A and 3B), allowing handling operations within the enclosure by means of a glove attached in sealed fashion to the glove ports. The walls also comprise at least one bag port 67.2 (FIG. 3B) allowing bags or containers to be attached in sealed fashion in order to introduce objects into the enclosure, or remove objects from it, in a sealed fashion. The containers can be flexible or rigid.

Grids 69 are positioned at the upper end of hopper 60, for example four such grids resting on a frame represented in FIG. 3D.

Sealing means are comprised between cover 68 and aperture 66 of enclosure 62, together with means 74 for locking the cover in a closed position, for example in the form of a flange.

Cover 68 is advantageously fitted with two jacks 72 making it easier to open it and keep it in an open position.

The opening and closing of cover 68 can be manual or automated, by electrical, pneumatic, etc. means.

Enclosure 62 comprises means to attach a consumable sleeve 84 (which can be seen in FIG. 7B), for example a flexible plastic bag, intended to cover the interior of the enclosure. These attachment means are installed in the area of aperture 66, outside the enclosure, such that sleeve 84 covers the edge of aperture 66. The attachment means are formed, for example, by a ring gripping the edge of the bag against the outer face of the side wall of the enclosure.

(Unrepresented) means creating a depression inside the hopper assembly are preferentially comprised, causing the powder to be aspirated in the direction of the tank.

In FIG. 6 a schematic section view of a drum used preferentially in the equipment according to the present invention can be seen, when the transferred powder material presents a certain danger.

Drum 2 comprises a side wall 74, a base 76, an aperture 78 and a cover 80 intended to close aperture 78 in sealed fashion. Powder material MP is confined in a first sealed flexible bag 81. A second bag 83 is preferably positioned inside the drum, and covers its internal surface; this bag also covers the edge of aperture 78 of the drum. The interior of drum 2 is therefore protected from the powder.

It is clearly understood that the drum can contain more than a first bag 81 loaded with powder material, that the powder material can be a blend of different materials, and/or that each bag does not comprise the same material. In addition, “powder material” is understood to mean a granular material, the size of the particles of which may be uniform or variable, ranging for example from several micrometres to several millimetres.

We shall now explain the process of transferring powder from a drum according to FIG. 6 into a tank 4.

In the initial state, drum 2 comprises a cover 80 which closes in sealed fashion the drum containing the powder contained in first sealed bag 81, which is itself positioned inside second bag 83, which covers the internal surface of the drum.

At the start of the transfer phase, cover 80 is removed and aperture 78 of the drum is covered with a cap 82 isolating the interior of the drum from the external environment, as can be seen in FIG. 7A.

The gripper device is then brought close to drum 2 by operating the trolley and hoist 8 such that hollow cylindrical body 14 surrounds and covers drum 2, and hollow cylindrical body 14 is positioned such that lobes 18, which are in the closed position, are now in their upper position, and cover cap 82 covering drum 2. This step can be seen in the left-hand half-view of FIG. 4B.

Drum 2 is then immobilised in hollow cylindrical body 14, by activating immobilisation means 10, and handle 24 is folded back, applying jaws 20 against the drum.

The transfer device is then positioned on seating 48.

The operator then adjusts control wheel 40, causing hollow cylindrical body 14 to rotate around axis Y; hollow cylindrical body 14 is immobilised in this upside-down position by the locking means. The lobes are now in their lower position, and the powder contained in first bag 81, in the course of turning the drum upside-down, has fallen in and is now resting on lobes 18. This step can be seen in FIG. 4A; however, bag 81 is not represented.

Hollow cylindrical body 14 is then raised by hoist 8 to extract it from seating 48, and then moved in the direction of the hopper assembly by the hoist trolley along the travelling crane, until it is positioned above open enclosure 62 of the hopper assembly.

The interior of enclosure 62 is fitted with a third open bag 84.

Hollow cylindrical body 14 with upside-down drum 2 is then lowered, and enters enclosure 62. When it has reached a sufficiently low position in enclosure 62, which nonetheless allows lobes 18 to open, lobes 18 are opened by activating linear actuator 26, and moving tube 28 slides upwards, causing lobes 18 to rotate downwards. This step can be seen in FIG. 2; however, bags 81 and 83 are not represented.

First bag 81 containing the powder falls into the base of enclosure 62 on the grids, carrying with it cap 82 and second bag 83.

Hollow cylindrical body 14 with empty drum 2 is removed from enclosure 62 by operating hoist 8.

Advantageously, after removal of the frame and of the empty drum, aperture 66 of the enclosure can be covered with a cap 86 (FIG. 7B) before cover 68 is closed, which enables the enclosure to be confined in preparation for opening the bags, and any transfer between the interior of the enclosure and the exterior to be prevented. In FIG. 7B the hopper assembly with powder bag 81 and cap 86 can be seen.

Cover 68 of the enclosure is then lowered and locked.

An air depression is then applied throughout the hopper assembly to provide a dynamic confinement.

If the powder is uranium oxide, in a particularly advantageous manner, when the enclosure is closed a nitrogen inerting of the interior of the enclosure is undertaken instead of generating an air depression. This inerting consists in generating a nitrogen depression of between, for example, −120 MPa and −80 MPa, reducing the risk of heating resulting from an exothermal reaction relating to a possible change of the degree of oxidation of the uranium oxide. Advantageously, in order to increase safety, an additional air depression is provided, in the event that the nitrogen depression no longer provides the dynamic confinement.

The bags are then opened to enable the powder to flow through the grids towards hopper 60 and into tank 4. Cutting is accomplished through the glove ports, a cutting tool being provided inside the enclosure. This cutting could be accomplished automatically, with one or more retractable cutting tools positioned near the grids, which tools would be deployed when it was desired to cut the bags.

First 81 and second 83 bag of the drum, the cap of the drum and the bag fitted to the interior of the enclosure are then evacuated via bag port 67.2, as a waste product in a sealed container.

The powder traverses the grid. The powder may be subjected to horizontal to-and-fro movements, to facilitate its passage through the grids, where these movements are applied manually or automatically, for example by means of a vibrator.

In addition, drum 2 is then released from hollow cylindrical body 14, the cover is replaced, and the drum can be reused. Its internal surface has not, indeed, been soiled by the powder. The method of emptying the drum and transferring the powder material is particularly suitable for handling powder material requiring major precautions. However, this method is in no sense restrictive. Indeed, the number of confinement bags depends on the level of danger of the handled powders. For example, second bag 83 may be omitted, and also third bag 84 in the enclosure.

The equipment according to the present invention associated with the storage of the powder in a bag enables the confinement means to be simplified; indeed, it is no longer necessary to have the powder confined permanently, but only when the bag is opened.

1. A drum-handling device leading to a hopper assembly for transferring at least one powder material contained in the drum towards an area for storage of said material, said drum (2) containing at least one closed bag containing said at least one powder material, said drum-handling device comprising:
a frame configured to be suspended from a hoist,
a hollow cylindrical body installed in the frame which can pivot around a horizontal axis perpendicular to a lengthways axis of the hollow cylindrical body, and said hollow cylindrical body containing the drum being configured to enter into the hopper assembly, the hollow cylindrical body comprising a first open lengthways end, a second lengthways end equipped with a closure of said second lengthways end, said closure being retractable, the internal dimensions of the hollow cylindrical body being such that they allow the drum to be introduced into the hollow cylindrical body, this body having means of immobilising the drum in the hollow cylindrical body, and means able to cause a 180° rotation of the hollow cylindrical body around its axis of rotation relative to the frame.

2. A drum-handling device according to claim 1, comprising means of locking the hollow cylindrical body in an upside-down position.

3. A drum-handling device according to claim 1, in which the retractable closure comprises at least two lobes connected such that they are able to rotate on the hollow cylindrical body, and at least one linear actuator installed on the hollow cylindrical body connected to the lobes by connecting rods.

4. A drum-handling device according to claim 3, in which the linear actuator is installed on the hollow cylindrical body opposite its closed second lengthways end, said linear actuator being connected to the connecting rods by means of a tube which can move along the lengthways axis of the hollow cylindrical body, and which forms an outside wall of said hollow cylindrical body.

5. A drum-handling device according to claim 3, in which the linear actuator is a irreversible linear actuator.

6. A drum-handling device according to claim 1, in which the immobilisation means are such that they come into contact with the drum in its median part.

7. A drum-handling device according to claim 1, in which the immobilisation means comprise at least two holding jaws configured to come into contact with the external surface of the drum and means able to apply the holding jaws on to the drum, and keep them pressed on it.

8. A drum-handling device according to claim 7, in which said means able to apply the holding jaws on to the drum, and keep them pressed on it, comprise handles accessible from outside the hollow cylindrical body, and imparting action to the holding jaws by means of toggle mechanisms.

9. A drum-handling device according to claim 1 in which the means for turning the drums upside-down comprise a toothed wheel engaged with the rotary shaft of the hollow cylindrical body, a toothed wheel on the frame, a transmission element connecting the two toothed wheels, and means to cause the toothed wheel on the frame to rotate.

10. A drum-handling device according to claim 9, in which the means to cause the toothed wheel on the frame to rotate comprise a control wheel connected to said toothed wheel by a reducing gear.

11. A drum-handling device according to claim 1, comprising a device to support the frame, to allow it to be stored and to turn the hollow cylindrical body upside-down.

12. A hopper assembly comprising a hopper configured to be connected by its downstream end to a tank of powder material, and a sealed enclosure installed in sealed fashion on the downstream end of the hopper, said enclosure comprising a side wall, a base on the side of the hopper and an aperture (66) opposite said base configured to enable the drum held in the hollow cylindrical body of the drum-handling device according to claim 1 to be introduced into the enclosure, the drum being in an upside-down position, with the aperture downwards; the enclosure also comprises a cover to close said aperture in sealed fashion, a sealed system allowing intervention in the enclosure, and a system for sealed transfer of the objects between the interior of the enclosure and outside of it, the base of the enclosure being formed at least partly by a grid positioned between the enclosure and the hopper.

13. A hopper assembly according to claim 12 in which the internal dimensions of the enclosure and of the aperture of the enclosure are then made such that they enable the hollow cylindrical body and the frame surrounding the hollow cylindrical body to be introduced into the enclosure.

14. A hopper assembly according to claim 12, comprising generator of a depression within the hopper assembly, generating a nitrogen and/or air depression.

15. A hopper assembly according to claim 12 in which the sealed system of access and the system for transferring in sealed fashion are formed in the side wall and are glove ports and bag ports respectively.

16. A hopper assembly according to claim 12, comprising a consumable sleeve fitted to the interior of the side wall of the enclosure and the base of the enclosure.

17. Drum-handling equipment for transferring powder from a drum into a tank according to claim 1 including a hopper assembly having sealed system of access and the system for transferring in sealed fashion are formed in the side wall and are glove ports and bag ports respectively.

18. A method for transferring powder material contained in a drum to a tank, the powder material being stored in at least a first bag in the drum, comprising the following steps:
opening of the drum,
installation of the hollow cylindrical body around the drum, the sealing means (16) being positioned above the aperture of the drum,
immobilisation of the drum in the hollow cylindrical body,
turning of the drum upside-down,
installation of the hollow cylindrical body and of the drum in the enclosure,
operation of the sealing means to allow said first bag of powder material to fall, with said first bag then resting on the grid,
removal of the hollow cylindrical body and of the drum,
closure of the aperture of the enclosure in sealed fashion,
start-up of the depression system,
opening of the first bag,
emptying of the first bag in the enclosure,
removal of the first bag.

19. A method of transfer according to claim 18 in which the drum comprises a second bag fitted to the interior of the drum, in which the first bag directly containing the powder material is positioned, comprising the step of installation of a cap on the aperture of the drum after the latter is opened, the second bag fitted to the interior of the drum and the cap falling into the enclosure at the same time as the first bag directly containing the powder material, and said second bag being perforated when the first bag directly containing the powder is opened.

20. A transfer method according to claim 18 comprising, before the hollow cylindrical body and the drum are introduced into the enclosure, the step of installation of a sleeve in the enclosure covering its side wall and its base, said sleeve being perforated when the first bag directly containing the powder is opened.

21. A transfer method according to claim 18 comprising the step of installation of a cap on the aperture of the enclosure after the removal of the hollow cylindrical body.

22. A method of transfer according to claim 18 in which, in order to accomplish the step of turning the drum upside-down, the frame is installed on the frame mount.
